(19) United States
(12) Patent Application Publication
(10) Pub. No.: US 2010/0332087 A1
(43) Pub. Date: Dec. 30, 2010

(54) Remote Vehicle Controller

(76) Inventors: Mark Robert Claffee, Methuen, MA (US); Timothy George Field, Randolph, MA (US)

Correspondence Address: O'Brien Jones, PLLC (w/iRobot Corp.), 1951 Kidwell Drive, Suite 550 B, Tysons Corner, VA, 22182, US

(21) Appl. No.: 12/822,820

(22) Filed: Jun. 24, 2010

Related U.S. Application Data
(60) Provisional application No. 61/220,128, filed on Jun. 24, 2009.

(51) Int. Cl. G06F 19/00

(52) U.S. Cl. 701/49

(57) ABSTRACT

The present teachings provide a controller for controlling a remote vehicle manipulator arm, the controller comprising a master arm morphologically the same as or similar to the remote vehicle manipulator arm, the master arm comprising two or more links connected to each other by joints, each joint comprising a slip clutch and a sensor for measuring a joint angle. An operator manipulates the master arm to control the remote vehicle manipulator arm such that a position of each manipulator arm joint is controlled based on a position of each master arm joint.

This application claims priority to U.S. Provisional Patent Application No. 61/220,128, filed Jun. 24, 2010, titled Remote Vehicle Controller, the content of which is incorporated herein in its entirety.

### Field

The present teachings provide simplified and intuitive control of a manipulator arm on a remote vehicle. The present teachings also provide simplified and intuitive control of manipulator arm such as a backhoe for digging remotely or in a typical cab-operated scenario.

### BACKGROUND

Operating a manipulator arm with several degrees of freedom can be a complex task and can be cumbersome when controlling each joint individually. To ease demands on an operator, “fly the gripper” and “fly the head” routines have been developed, allowing an operator to specify x, y, and z gripper velocity components using, for example, a joystick. “Fly the head” control schemes work essentially the same way as “fly the gripper” control schemes, the only difference being that it is a head on the manipulator arm that is driven, not a gripper. Joint velocities for the specified components are computed and then executed to achieve the desired gripper velocity. To accomplish this, a forward kinematic map and Jacobian matrix can be computed for the manipulator arm, for example as described in Johnson, et al., Manipulator Autonomy for EOD Robots, the disclosure of which is incorporated herein by reference in its entirety. Fielded control schemes such as “fly the gripper” and “fly the head” allow a remote vehicle operator to move one point of an arm in the remote vehicle in Cartesian space, but without the ability to control the manipulator arm's link locations during this operation.

In an operational scenario, an operator may find himself needing to bend the arm in a specific way to avoid obstacles while reaching a desired target with, for example, a gripper located on the manipulator arm. Thus, the operator needs to control the manipulator arm's link locations during the operation, which cannot be accomplished with existing “fly the gripper” and “fly the head” control schemes. Another drawback to these existing control schemes is that an operator has no way of driving the remote vehicle chassis while moving its manipulator arm. The ability to simultaneously control these two actions would be extremely helpful in performing digging and dragging tasks, which are commonly performed by EOD operators looking for command wires.

A controller previously developed by Robotic FX uses an arm that is somewhat morphologically similar to a robot arm to control the robot arm, being morphologically similar in that it has the same number of joints. The Robotic FX controller arm can be manipulated to cause a manipulator arm of an associated remote vehicle to be similarly manipulated, including relative positioning of the joints and a head an/or gripper of the remote vehicle manipulator arm. The Robotic FX manipulator arm controller has a constant “home” position, with variation of the joint angles from the home position being mapped to joint velocities. When the operator removes his hand from the Robotic FX controller, the arm springs back to its home configuration while the robot's manipulator arm maintains its position.

The difference between a controller in accordance with the present teachings and the Robotic FX controller is the state that is being controlled. The Robotic FX controller controls the velocity of each joint rather than its position, whereas present teachings control a position of each joint. Further, the Robotic FX controller can only be moved to a limited degree from its home position, and the farther away the master arm is from home, the faster the robot manipulator arm moves. This type of control does not provide the operator with knowledge of the robot manipulator arm's existing physical configuration (position). Thus, when performing tasks without line of sight to the controlled remote vehicle manipulator arm, the operator can easily loose track of arm geometry and become confused regarding the motion that control inputs will produce.

The Robotic FX controller employs springs to return the master arm to its home position and employs stops to prevent over-rotation. The Robotic FX controller is designed to be utilized with a standard base control station by plugging a device including the master arm into a base control station, and thus it does not include a controller that can drive the remote vehicle chassis.

### SUMMARY

The present teachings provide a controller for controlling a remote vehicle manipulator arm, the controller comprising a master arm morphologically the same as or similar to the remote vehicle manipulator arm, the master arm comprising two or more links connected to each other by joints, each joint comprising a slip clutch and a sensor for measuring a joint angle. An operator manipulates the master arm to control the remote vehicle manipulator arm such that a position of each manipulator arm joint is controlled based on a position of each master arm joint.

The present teachings also provide a controller for controlling a remote vehicle manipulator arm, the controller comprising: a housing; a master arm mounted to the housing and comprising the same number of links and joints as the remote vehicle manipulator arm, the links being connected to each other by joints, each joint comprising a sensor for measuring a joint angle; a drive controller mounted to the housing and configured to allow an operator to drive the remote vehicle while the operator controls the manipulator arm with the master arm; and at least one additional input device configured to allow control of aspects the remote vehicle's manipulator arm aside from its position.

The present teachings further comprise a method for controlling a remote vehicle having a manipulator arm comprising two or more manipulator arm links connected to each other by manipulator arm joints. The method comprises: controlling the manipulator arm by manipulating a master arm that is morphologically similar to or the same as the manipulator arm, the master arm comprising two or more master arm links connected to each other by master arm joints. The position of each manipulator arm joint is controlled based on a position of each master arm joint.

Objects and advantages of the present teachings will be set forth in part in the description which follows, and in part will be obvious from the description, or may be learned by practice of the present teachings. The objects and advantages of the present teachings can be realized and attained by means of the elements and combinations particularly pointed out in the appended claim.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and together with the description, serve to explain the principles of those teachings.

### BRIEF DESCRIPTION OF THE DRAWINGS

FIG. 1 illustrates an exemplary embodiment of a controller in accordance with the present teachings, including an exemplary master arm.

FIG. 2 illustrates the master arm for the controller of FIG. 1.

FIG. 3 illustrates another embodiment of a controller in accordance with the present teachings, including an exemplary backhoe-like master arm.

FIG. 4 illustrates an exemplary embodiment of a joint of a master arm of in accordance with the present teachings.

### DESCRIPTION OF THE EMBODIMENTS

Reference will now be made in detail to exemplary embodiments of the present teachings, examples of which are illustrated in the accompanying drawings.

The present teachings include a remote vehicle controller providing full and intuitive control of at least a manipulator arm on a controlled remote vehicle such as, for example, a PackBot® EOD robot. Full and intuitive control can be achieved in accordance with the present teachings by providing a master arm on the remote vehicle controller that is morphologically the same as or similar to the manipulator arm on the remote vehicle. Upon altering the position of the master arm on the controller to a given configuration, the remote vehicle manipulator arm can be driven to achieve a matching configuration. This can be accomplished by accurate scaling of the remote vehicle controller's master arm to the remote vehicle's manipulator arm, measuring angles of the joints of the controller master arm, and implementing slip clutches at each joint.

Translation of controller master arm position to remote vehicle manipulator arm position can be achieved as follows. The controller master arm can be calibrated to the remote vehicle manipulator arm initially and, in accordance with various embodiments, periodically thereafter. A microcontroller within the remote vehicle controller housing can continuously receive voltage output from a potentiometer at each joint, and determine an exact angle of each joint based on that voltage output. There is a linear correlation between the position of a potentiometer and its output voltage, which can be mapped to an absolute angle of a joint. A value corresponding to the absolute angle for each joint of the master arm can be sent to the remote vehicle, and the remote vehicle can move its manipulator arm in a known manner based on the sent value to mimic the position of the master arm. In certain embodiments of the present teachings, the remote vehicle also avoids self-collision (e.g., collision of the arm with the remote vehicle chassis or a payload thereof) while achieving the desired manipulator arm configuration.

In certain embodiments of the present teachings, a height of the remote vehicle controller housing can be scaled to match or represent a height of remote vehicle's manipulator arm from the ground. Thus, when the remote vehicle controller rests on, for example, a table surface, touching a controller master arm gripper, head, or other functional attachment to the table surface will translate to touching a remote vehicle's manipulator arm gripper, head, or other functional attachment to the ground (given a generally flat ground surface). Accurate vertical offset of the remote vehicle controller's master arm in accordance with the present teachings can be achieved by physical sizing of the controller housing or by revising calculations in control software as would be understood by those skilled in the art.

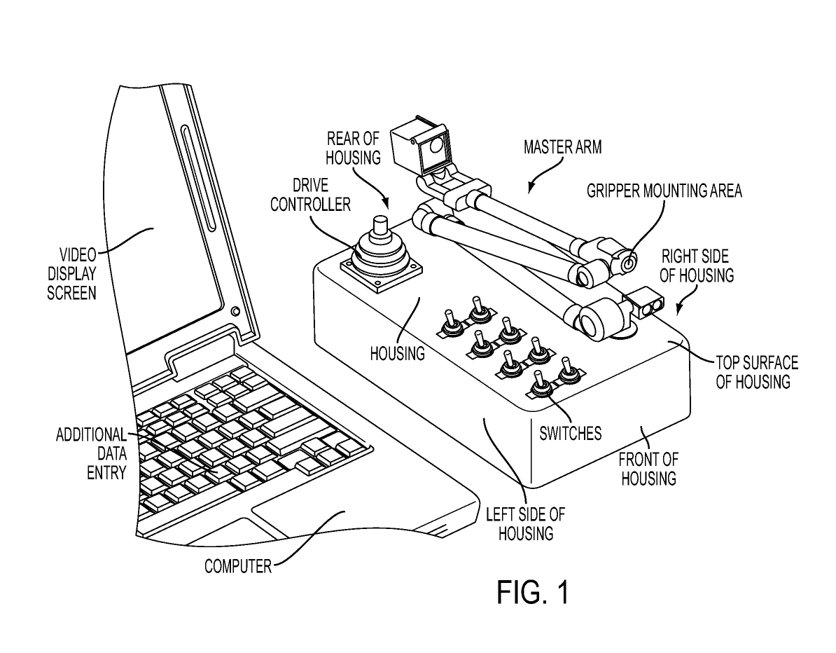

FIG. 1 illustrates an exemplary embodiment of a control system, including a remote vehicle controller having a master arm in accordance with the present teachings, a computer, and a video display. In the illustrated embodiment, the computer comprises a laptop computer and the video display comprises a laptop video display screen. Those skilled in the art will understand that other suitable computers can be utilized, for example a ruggedized computer typically deployed to control a remote vehicle used in military missions. The computer can be utilized to run control software and provide a communication data link to the remote vehicle being controlled. The computer can communicate with the remote vehicle controller via a communication cable such as a USB cable. Alternatively or additionally, the computer can communicate with the remote vehicle controller wirelessly, as would be understood by those skilled in the art.

The remote vehicle controller comprises a housing having front, rear, left, and right sides. The housing also has a top surface on which switches, a master arm, and a drive controller can be mounted.

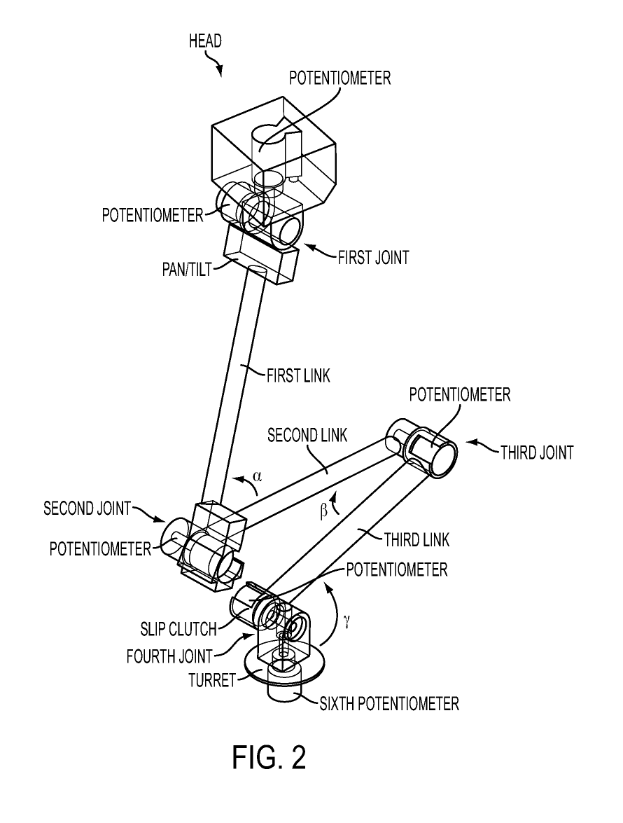

An exemplary embodiment of a master arm is illustrated in FIG. 2. In accordance with certain embodiments, the master arm comprises a turret that is mounted to the housing top surface. The turret can allow the master arm to rotate with respect to the housing in a horizontal plane (or in a plane parallel to the top surface of the illustrated housing). A potentiometer or other similar measurement device can be employed in the turret and used to measure the rotational position of the turret (and thus the master arm) with respect to the housing top surface. The master arm can also comprise a head, which can include a camera, often referred to as an attack camera, and other attachments. An attack camera is typically aimed at, for example, a gripper or other functional attachment of the remote vehicle manipulator arm, for which the operator desires a dedicated video feed. In accordance with certain embodiments, the attack camera can be a pan/tilt zoom camera and/or the head comprising the attack camera can be attached to the manipulator arm via a first rotating joint including a pan/tilt mechanism. Pan, tilt, and zoom are preferably provided for the attack camera to give it a range of motion, and thus an available view of the manipulator arm's environment, that is desired by an operator. The attack camera preferably pans around without moving the remote vehicle's manipulator arm.

In accordance with various embodiments, a second camera such as a drive camera can be mounted at a base of the manipulator arm and can face in a forward direction of the remote vehicle but, in certain embodiments, can be capable of panning to follow a direction of the remote vehicle's manipulator arm. Both cameras (attack and drive) can be used when operating grippers in an EOD scenario. By manipulating its position on the master arm, a controller in accordance with the present teachings can be used by an operator or in an autonomous manner to aim the attack camera of the remote vehicle manipulator arm (e.g., to remain focused on a gripper in an EOD robot).

In accordance with certain embodiments such as the illustrated exemplary embodiments, a first joint of the master arm can have a single degree of freedom and comprise a potentiometer or other device for measuring the rotational position of the first joint. The first joint in the embodiment of FIG. 2 connects the pan/tilt to the head. The present teachings contemplate switching the locations of the pan/tilt and the first joint, so that the first joint connects a first link to the pan/tilt and the pan/tilt connects to the head. The first link of the master arm can be connected to a second link or the master arm via a second joint of the master arm, allowing the first and second links to pivot with respect to each other such that an angle β between the first and second links can vary. The second joint can comprise a potentiometer or other device for measuring the rotational position of the second joint. The second link can be connected to a third link of the master arm via a third joint, allowing the second and third links to pivot with respect to each other such that an angle β between the second and third links can vary. The third joint can comprise a potentiometer or other device for measuring the rotational position of the third joint. The third link can be connected to the turret via a fourth joint of the master arm, allowing the third link to pivot with respect to the turret or the housing top surface to which the turret is mounted in the illustrated example, such that an angle γ between the third link and the turret or housing top surface can vary. The fourth joint can comprise a potentiometer or other device for measuring the rotational position of the fourth joint and as stated above, a potentiometer can additionally be employed to measure a rotational position of the turret with respect to the remote vehicle chassis.

In certain embodiments, the second, third, and fourth joints of the master arm and the corresponding joints of the remote vehicle's manipulator arm can have a single degree of freedom. If the joints of the remote vehicle's manipulator arm have more than one degree of freedom, the present teachings contemplate the joints of the associated controller master arm also having more that one degree of freedom.

In accordance with certain embodiments, the remote vehicle manipulator arm and the controller master arm can have, overall, six degrees of freedom, which can be achieved using six independent single degree-of-freedom joints—none of which are redundant. The six joints can include the first through fourth joints illustrated in FIG. 2, in addition to the panning mechanism of the pan/tilt for the attack camera and the turret.

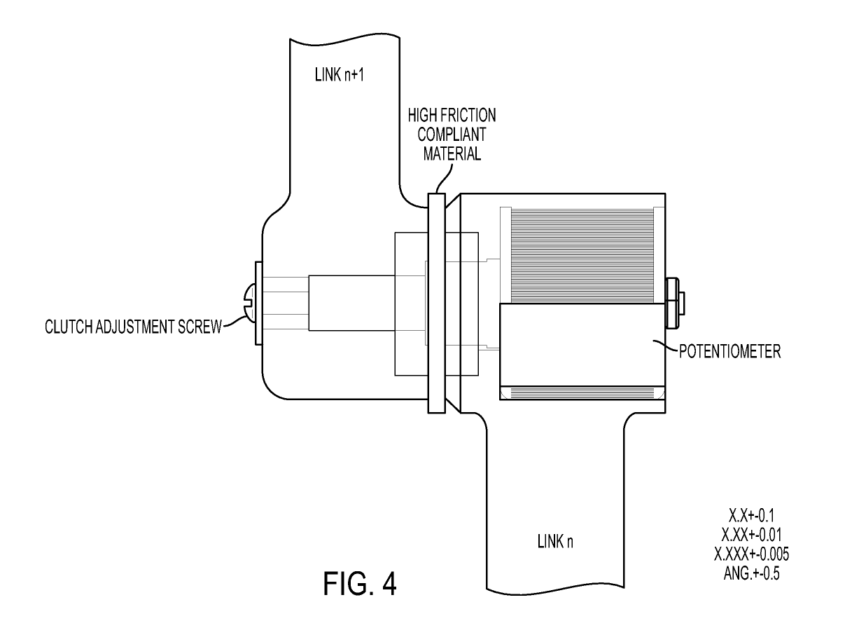

FIG. 4 provides a detailed illustration of an exemplary embodiment of a joint in accordance with the present teachings. Potentiometers can be utilized, as set forth above, to provide accurate signals representing an angle of rotation of each joint of the controller master arm. Signals representative of the angle of rotation of each joint of the controller master arm can be sent periodically or continuously to the control system to cause the control system to move the remote vehicle manipulator arm in the same or a similar manner as the controller master arm.

Using a controller master arm that is morphologically the same as or similar to an arm being manipulated can allow novice operators to quickly and accurately perform complex manipulation tasks in an intuitive manner. The master arm can optionally comprise representative portions that represent attachments to the remote vehicle manipulator arm, such as a head and a gripper, to provide the operator with a more realistic model of the remote vehicle manipulator arm that he is controlling.

As depicted generally in FIGS. 2 and 4, each of first through fourth joints of an exemplary embodiment of a master arm for the controller of FIG. 1 comprises a slip clutch. In accordance with certain embodiments, slip clutches can be utilized in at least one of the first through fourth joints, for example in each joint. A slip clutch is essentially a friction clutch that temporarily disengages if it reaches a higher level of torque than it is designed to handle. An implementation of a slip clutch in accordance with the present teachings can comprise compressing a high friction, compliant material between two joint halves as illustrated in FIG. 4. Adjusting the compressive force between the joint halves can allow the user to set the slip clutch stiffness. Adjustment can be accomplished by a screw extending through the joint, where tightening the screw increases compressive force. One skilled in the art will understand that other known implementations of slip clutches can also be utilized in accordance with the present teachings.

The controller can also comprise one or more switches allowing control of the remote vehicle, and particularly allowing control of aspects the remote vehicle's manipulator arm aside from its position. In certain embodiments, the switches can control, for example, opening and closing a gripper, rotating the gripper, selecting among one or more cameras such as drive and attack cameras, zooming the camera(s), and turning a remote vehicle brake on and off. The remote vehicle brake can control every actuator on the arm and can be employed as a safety measure (e.g., when a person is working around the remote vehicle) or to conserve power. The present teachings contemplate a variety of locations for the switches, for example on a top surface of the housing as illustrated, on the master arm, and/or on the drive controller. The switches can be, for example, positioned on the top and sides of the master arm and/or the drive controller in one or more ergonomically correct positions for activation of the switches while manipulating the master arm and/or the drive controller, in a manner similar to known flight simulator joysticks.

In various embodiments, the controller comprises a drive controller allowing an operator to drive the remote vehicle while manipulating the master arm. The drive controller can comprise, for example, a two degree-of-freedom analog joystick as illustrated in FIG. 1. The drive controller can alternatively comprise a joystick having more than two degrees of freedom or a puck having up to six degrees of freedom. Using a controller in accordance with the present teachings, such as that illustrated in FIGS. 2 and 4, an operator can drive the remote vehicle with his left hand while controlling the remote vehicle's manipulator arm with his right hand.

In certain embodiments of the present teachings, the master arm can be disposed on the housing top surface such that it faces in another direction that that shown in FIG. 1, for example an opposite direction from that shown in FIG. 1 (i.e., such that in a resting position the gripper. Such an arrangement would be advantageous in embodiments employing a gripper, allowing the gripper (mounted at the gripper mounting area shown in FIG. 1) to face away from the operator in a more intuitive position for manipulation. In various embodiments of the present teachings, an additional input device can be employed for operator control unit (OCU) input, for example a laptop keyboard as illustrated in FIG. 1 or a mouse, and can be used, for example, to log into the remote vehicle or to control a camera to take a snapshot of a remote vehicle environment.

The present teachings contemplate using a controller in accordance with the present teachings to cause a gripper on the remote vehicle's manipulator arm to dig by scraping the gripper along the ground surface. The operator can achieve such a digging motion via a controller in accordance with the present teachings by manipulating the controller master arm such that its gripper scrapes along a surface of a table or other structure on which the controller housing rests. For such an operational scenario, it is particularly advantageous if a height of the remote vehicle controller housing can be scaled to match or represent a height of remote vehicle's manipulator arm from the ground as disclosed above.

A controller and method in accordance with the present teachings can also be used for remote control of other devices or vehicles such as, for example, a backhoe. A backhoe can comprise a piece of excavating equipment or digger including a digging bucket on a distal end of a two-part articulated arm. The bucket and two-part arm are typically mounted on the back of a vehicle such as a tractor or front loader, but could alternatively be mounted on a remotely-controlled vehicle such as a robot. The section of the two-part arm closest to the vehicle is known as the boom, and the section of the two-part arm that carries the bucket is known as the dipper. The boom is typically attached to the vehicle via a pivot known as a kingpost, which can allow the two-part arm to slew left and right, usually through an angle of about 200 degrees.

When an operator controls a backhoe vehicle from a location other than its cab, the present teachings consider the backhoe vehicle to be a remote vehicle because it is being controlled remotely.

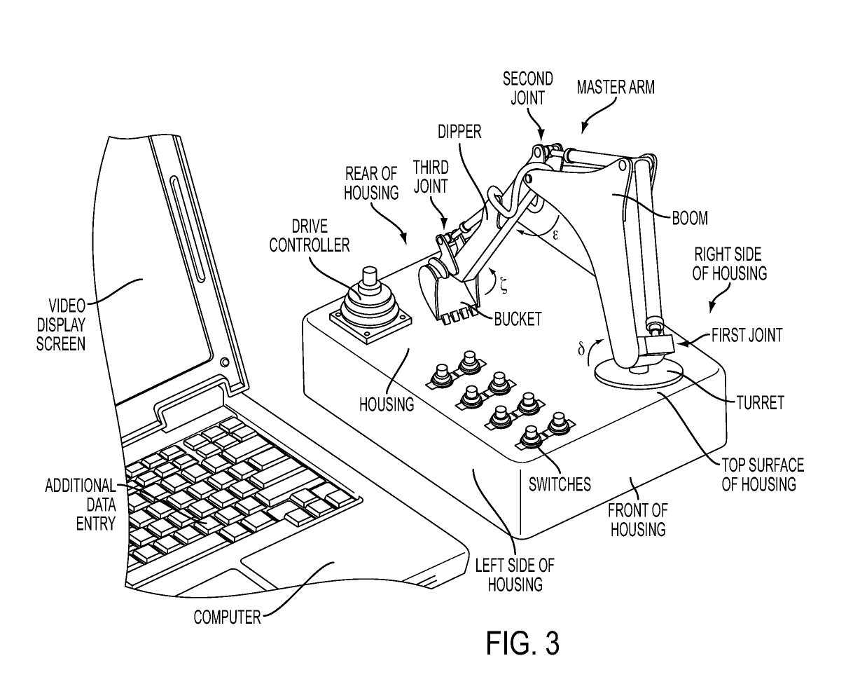

An exemplary embodiment of a controller equipped with a manipulable backhoe-like master arm is illustrated in FIG. 3. In accordance with certain embodiments, the backhoe-type master arm of the controller can be mounted to the housing via a turret in a manner similar to the controller embodiment of FIG. 1, allowing the backhoe arm to rotate in a horizontal plane with respect to the housing similar to slewing of the actual backhoe left and right. Alternatively, the backhoe-type master arm can be mounted to the housing in a manner similar to the way a backhoe is mounted to a tractor, or in such other manner that the backhoe-type master arm can slew left and right through an angle of about 200 degrees in the same manner as the actual arm being controlled. A potentiometer or other device can be employed to measure the rotational position of the turret (and thus the master arm) with respect to the housing top surface. Rotation of the master arm can be limited to the slewing capabilities of the backhoe being controlled.

In certain embodiments, a camera (not shown in FIG. 3) can be placed on or adjacent the backhoe and a video feed from the camera can be made available to the operator to assist the operator in controlling the backhoe. Placement of the camera should provide a safe location for the camera that provides an operator with a suitably useful view of the backhoe bucket in use. However, the present teachings also contemplate a backhoe controller for use without a camera feed, in a line-of-sight implementation, whereby the operator is in a cab of the backhoe or within sight of the backhoe bucket.

In accordance with certain embodiments, a first joint of FIG. 3 can connect the backhoe arm to the turret, allowing the boom to pivot with respect to the housing top surface such that an angle δ between the boom and the housing top surface can vary. The first joint can comprise a potentiometer or other device for measuring the rotational position of the first joint. The boom can be connected to a dipper via a second joint allowing the boom and the dipper to pivot with respect to each other such that an angle ε between the boom and dipper varies. The second joint can comprise a potentiometer or other device for measuring the rotational position of the second joint. The dipper can be connected to a bucket via a third joint allowing the dipper and the bucket to pivot with respect to each other such that an angle between the dipper and the bucket varies. The third joint can comprise a potentiometer or other device for measuring the rotational position of the third joint.

The first and second joints of the master arm and the corresponding joints of the backhoe can have a single degree of freedom. As stated above, FIG. 4 provides a detailed illustration of an exemplary embodiment of a single degree-of-freedom joint in accordance with the present teachings. Potentiometers can be utilized with the joint in a known manner to provide accurate signals representing an angle of rotation of each joint of the controller master arm. Signals representative of the angle of rotation of each joint of the controller master arm can be sent periodically or continuously to the control system to cause the control system to move the backhoe in the same or a similar manner as the controller master arm.

In the embodiment of FIG. 3, using a controller master arm that is morphologically the same as or similar to the backhoe being controlled can allow novice operators to quickly and accurately perform complex manipulation tasks in an intuitive manner. The master arm can optionally comprise representative portions that represent attachments to the remote vehicle manipulator arm, such as a camera trained on the backhoe bucket, to provide the operator with a more realistic model of the actual backhoe that he is controlling.

As depicted generally in FIGS. 2 and 4, each of the master arm joints depicted in the backhoe-like master arm can comprise a slip clutch. In accordance with certain embodiments, slip clutches can be utilized in at least one of the joints, for example in each joint. As stated above, the slip clutch can comprise a friction clutch that temporarily disengages if it reaches a higher level of torque than it is designed to handle. An implementation of a slip clutch in accordance with the present teachings can comprise compressing a high friction, compliant material between two joint halves as illustrated in FIG. 4. Adjusting the compressive force between the joint halves can allow the user to set the slip clutch stiffness. Adjustment can be accomplished by a screw extending through the joint, where tightening the screw increases compressive force. One skilled in the art will understand that other known implementations of slip clutches can also be utilized in accordance with the present teachings.

The controller can also comprise one or more switches allowing remote control of certain functions relevant to backhoe operation, for example selecting among one or more cameras if available, zooming the camera(s), turning a backhoe brake on and off, and engaging and disengaging stabilizer bars that are commonly engaged during backhoe operation.

In various embodiments, the controller also comprises a drive controller allowing an operator to remotely drive a vehicle on which the backhoe is mounted, while manipulating the backhoe two-part arm and bucket with the master arm. The drive controller can comprise, for example, a two degree-of-freedom analog joystick as illustrated in FIG. 3. The drive controller can alternatively comprise a joystick having more than two degrees of freedom or a puck having up to six degrees of freedom. Using a controller in accordance with the present teachings, an operator can drive the vehicle with his left hand while manipulating the backhoe-like master arm with his right hand.

In various embodiments of the present teachings, an additional input device can be employed for OCU input, for example a laptop keyboard as illustrated in FIG. 3 or a mouse, and can be used, for example, to log into the remote vehicle or to control a camera to take a snapshot of a remote vehicle environment.

If the joints of the backhoe have more than one degree of freedom, the present teachings contemplate the joints of the associated controller master arm also having more that one degree of freedom.

In an exemplary digging process utilizing the controller embodiment illustrated in FIG. 3, wherein the master arm comprises a backhoe bucket attached to a two-part arm, an operator can drive a vehicle on which the backhoe is mounted by sitting inside the backhoe cab (not shown) as would be understood by those skilled in the art, or by utilizing the drive controller on the top surface of the controller housing. The drive controller can be utilized in conjunction with line-of-sight observation of the backhoe and/or with video feed from a drive camera, if available, as displayed to the operator on the computer video display screen. The vehicle on which the backhoe is mounted can be driven to within a predetermined distance of an area for digging and one or more switches can be activated to turn on the brake and/or engage the stabilizer bars, as necessary. The bucket can then be intuitively manipulated by the operator via controller master arm manipulation to cause the backhoe to dig in a known manner.

In embodiments employing a backhoe-like master arm to be used in digging operations, a height of the controller housing is preferably (but not necessarily) scaled to match or represent a height of actual backhoe from the ground so that, when the controller housing rests on a surface such as a table surface, touching the bucket of the master arm to the table surface will translate to touching the actual backhoe's bucket to the ground (given a generally flat ground surface). Accurate vertical offset of the master arm can be achieved by physical sizing of the controller housing or by revising calculations in control software as would be understood by those skilled in the art.

In accordance with certain embodiments, a backhoe-like master arm such as that illustrated in FIG. 3 can be mounted in a cab of a vehicle comprising a backhoe. The master arm can be mounted, for example, on an existing control panel of the vehicle, allowing a backhoe operator to control the two-part arm and bucket from within the cab in a more intuitive manner, via line-of-sight and/or a video feed from a strategically-mounted camera.

Although real-time control of an actual manipulator arm with a morphologically similar master arm may not be fully achievable, certain embodiments of the present teachings can approach real-time control by employing damping, e.g., mechanical damping via slip clutches, to slow movement of the controller master arm to match the speed capabilities of the manipulator arm on the remote vehicle. Alternatively or additionally, the present teachings contemplate allowing an operator to manipulate the controller master arm to a variety of preset poses, which are then matched by the remote vehicle manipulator arm at achievable speeds.

The present teachings contemplate the operator simultaneously utilizing the drive controller and the master arm to move the remote vehicle and its arm simultaneously, for example for digging. When digging, it is common to drive the vehicle forward, reach forward (away from the vehicle) with the manipulator arm to engage the ground, and pull the portion of the manipulator arm (e.g., a gripper or a backhoe bucket) engaging the ground backward (toward the vehicle) in a digging motion. As the portion of the manipulator arm is engaging the ground, it may be desirable to drive the vehicle backward and continue dragging the manipulator arm along the ground, for example when looking for command wires.

Other embodiments of the present teachings will be apparent to those skilled in the art from consideration of the specification and practice of the teachings disclosed herein. It is intended that the specification and examples be considered as exemplary only, with a true scope and spirit of the present teachings being indicated by the following claims.

What is claimed is:

1. A controller for controlling a remote vehicle manipulator arm, the controller comprising:
a master arm morphologically the same as or similar to the remote vehicle manipulator arm, the master arm comprising two or more links connected to each other by joints, each joint comprising a slip clutch and a sensor for measuring a joint angle,
wherein an operator manipulates the master arm to control the remote vehicle manipulator arm such that a position of each manipulator arm joint is controlled based on a position of each master arm joint.

2. The controller of claim 1, further comprising a drive controller including one of a joystick and a puck.

3. The controller of claim 1, wherein the sensor for measuring a joint angle comprises a potentiometer.

4. The controller of claim 1, further comprising at least one additional input device configured to allow control of aspects the manipulator arm aside from its position.

5. The controller of claim 4, wherein the at least one additional input device comprises one or more of a button and a switch.

6. The controller of claim 4, wherein the at least one additional input device is located on the master arm.

7. The controller of claim 1, further comprising a housing on which the master arm is mounted, the housing having a height that is scaled to match or represent a height of the remote vehicle's manipulator arm from the ground.

8. A controller for controlling a remote vehicle manipulator arm, the controller comprising:
a housing;
a master arm mounted to the housing and comprising the same number of links and joints as the remote vehicle manipulator arm, the links being connected to each other by joints, each joint comprising a sensor for measuring a joint angle;
a drive controller mounted to the housing and configured to allow an operator to drive the remote vehicle while the operator controls the manipulator arm with the master arm; and
at least one additional input device configured to allow control of aspects the remote vehicle's manipulator arm aside from its position.

9. The controller of claim 8, wherein each joint further comprises a slip clutch.

10. The controller of claim 8, wherein the drive controller comprises one of a joystick and a puck.

11. The controller of claim 8, wherein the sensor for measuring a joint angle comprises a potentiometer.

12. The controller of claim 8, wherein the at least one additional input device comprises one or more of a button and a switch.

13. The controller of claim 12, wherein the at least one additional input device is located on the master arm.

14. The controller of claim 8, wherein the housing has a height that is scaled to match or represent a height of the remote vehicle's manipulator arm from the ground.

15. A method for controlling a remote vehicle having a manipulator arm comprising two or more manipulator arm links connected to each other by manipulator arm joints, the method comprising:
controlling the manipulator arm by manipulating a master arm that is morphologically similar to or the same as the manipulator arm, the master arm comprising two or more master arm links connected to each other by master arm joints, the position of each manipulator arm joint being controlled based on a position of each master arm joint.

16. The method of claim 15, wherein each master arm joint comprises a sensor for measuring a joint angle.

17. The method of claim 15, further comprising driving the remote vehicle by manipulating a drive controller while controlling the manipulator arm by manipulating the master arm.

18. The method of claim 17, further comprising driving the remote vehicle by manipulating a drive controller while controlling the manipulator arm by manipulating the master arm to perform digging and dragging tasks.

19. The method of claim 18, wherein the master arm is mounted to a controller housing, and further comprising causing a gripper of the manipulator arm to scrape along the ground by manipulating the master arm such that a gripper of the master arm scrapes along a surface of a table or other structure on which the controller housing rests.

20. The method of claim 15, further comprising approaching real-time control of the manipulator arm by employing damping to slow movement of the master arm to match speed capabilities of the manipulator arm

21. The method of claim 15, further comprising manipulating the master arm to a variety of preset poses, the preset poses being matched by the manipulator arm at achievable speeds.
